(19) United States
(12) Patent Application Publication
(10) Pub. No.: US 2015/0127961 A1
(43) Pub. Date: May 7, 2015

(54) METHOD, DEVICE, PLATFORM, AND MOBILE TERMINAL FOR RECORDING AND ANALYZING BATTERY POWER OF A MOBILE TERMINAL

(71) Applicant: Tencent Technology (Shenzhen) Co., Ltd., Shenzhen (CN)

(72) Inventor: Louyi Huang, Shenzhen (CN)

(21) Appl. No.: 14/597,043

(22) Filed: Jan. 14, 2015

Related U.S. Application Data
(63) Continuation of application No. PCT/CN2014/082196, filed on Jul. 15, 2014.

(30) Foreign Application Priority Data
Jul. 15, 2013 (CN) 201310296589X

(51) Int. Cl. G06F 1/32

(52) U.S. Cl. CPC G06F 1/3212
USPC 713/320

(57) ABSTRACT

A method and a device for recording and analyzing the battery power of a mobile terminal have been disclosed. The method includes the following operations: obtaining recorded data of battery power in a mobile terminal over a predetermined time duration; utilizing a preset retrieving strategy, retrieving battery power charging/discharging data from the recorded data of the battery power, and statistically analyzing the battery power charging/discharging data to obtain a statistical analysis result; displaying the statistical analysis result on the mobile terminal. The method improves the accuracy of statistical data on battery power, and provides more accurate analysis and forecast of battery use status based on statistical data on battery power.

### CROSS-REFERENCE TO RELATED APPLICATIONS

The application is a continuation of PCT Application No. PCT/CN2014/082196, filed on Jul. 15, 2014, which claims priority to Chinese Patent Application No. 201310296589X, filed on Jul. 15, 2013, which may be incorporated by reference in their entireties.

### FIELD OF THE TECHNOLOGY

The present disclosure relates to a method, device, platform, and mobile terminal for recording and analyzing the battery power of a mobile terminal in the field of communication technologies.

### BACKGROUND

As a smart smartphone operating system launched by Microsoft, Windows Phone integrates Xbox Live game, Xbox Music, and unique video experience under the flag of Microsoft into a mobile phone, thus bringing brand-new application experience to smartphone users.

While smartphones provide more and more application experiences, power consumption of the smartphone batteries has become an increasing problem with great concern for users. The existing Windows Phone platform may usually record and display all records of power consumption of battery power. However, due to system restrictions, the Windows Phone platform usually may be able to record or sample readings on the battery power at every half an hour interval. Since half an hour interval is a long duration, the obtained statistics on the battery power are not accurate enough. In addition, the existing display mode for the battery power usually enumerates the battery power records only, but provides little insight to users to accurately monitor power consumption and accurately estimate the battery life.

### SUMMARY

The embodiments of the present disclosure provide a method, device, platform, and mobile terminal for recording and analyzing the battery power of a mobile terminal, thereby improving the accuracy of battery power statistics and ensuring reasonable usage of batteries.

In an embodiment, a method for recording and analyzing the battery power of a mobile terminal is disclosed, which includes the exemplary operations of: obtaining recorded data of battery power in a mobile terminal over a predetermined time duration; utilizing a preset retrieving strategy, retrieving battery power charging/discharging data from the recorded data of the battery power, and statistically analyzing the battery power charging/discharging data to obtain a statistical analysis result; and displaying the statistical analysis result on the mobile terminal.

In another embodiment, a device for recording and analyzing the battery power of a mobile terminal is disclosed. The device may include at least a processor with circuitry operating in conjunction with at least a memory which stores instruction codes operable as plurality of modules, wherein the plurality of modules may include: an acquisition module, which obtains recorded data of battery power in a mobile terminal over a predetermined time duration; and retrieving and analyzing module, which utilizes a preset retrieving strategy, retrieves battery power charging/discharging data from the recorded data of the battery power, and statistically analyzes the battery power charging/discharging data to obtain a statistical analysis result; and a displaying module, which displays the statistical analysis result on the mobile terminal.

Yet in another embodiment, a non-transitory computer-readable storage medium is disclosed, wherein the computer readable storage medium stores a program which includes codes or instructions to cause a processor circuitry to execute operations for recording and analyzing the battery power of a mobile terminal, the operations include: obtaining recorded data of battery power in a mobile terminal over a predetermined time duration; utilizing a preset retrieving strategy, retrieving battery power charging/discharging data from the recorded data of the battery power, and statistically analyzing the battery power charging/discharging data to obtain a statistical analysis result; and displaying the statistical analysis result on the mobile terminal.

The above method and device for recording and analyzing the battery power of a mobile terminal not only improve the accuracy of statistical data on battery power, but also provide a more accurate analysis and forecast on the battery power usage status, which is based on statistical analysis of battery power data under various task operations being run, thus offer more reasonable scenarios and power consumption status on the battery life so that the user may optimize the operations (such as deciding to keep certain applications on, or continue to connect to a network or not) performed on the mobile terminal.

### BRIEF DESCRIPTION OF THE DRAWINGS

FIG. 1 shows a flowchart illustrating an exemplary method for recording and analyzing battery power of a mobile terminal, according to an embodiment of the disclosure.

FIG. 2 is a diagram depicting an exemplary battery power consumption vs time curve in a mobile terminal, according to an embodiment of the disclosure.

FIG. 3 shows a flowchart illustrating an exemplary statistical analysis of battery power consumption of a mobile terminal, according to an embodiment of the disclosure.

FIG. 4 shows a flowchart illustrating an exemplary statistical analysis of battery power charging capacity of a mobile terminal, according to an embodiment of the disclosure.

FIG. 5 shows exemplary schematic functional modules which record and analyze battery power data of a mobile terminal, according to an embodiment of the disclosure.

FIG. 6 shows a detail schematic functional diagram of an acquisition module of the device for recording and analyzing the battery power of a mobile terminal, according to an embodiment of the disclosure.

FIG. 7 shows a detail schematic functional diagram of a retrieving and analyzing module of the device for recording and analyzing the battery power of a mobile terminal, according to an embodiment of the disclosure.

FIG. 8 shows another detail schematic functional diagram of the retrieving and analyzing module of the device for recording and analyzing the battery power of a mobile terminal, according to an embodiment of the disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment may be described in details. Similar features may be referenced back to the prior descriptions in a prior numbered drawing or referenced ahead to a higher numbered drawing.

FIG. 1 shows a flowchart illustrating an exemplary method for recording and analyzing battery power of a mobile terminal, according to an embodiment of the disclosure. The method includes at least the following exemplary operations.

Step S101: Obtaining recorded data of battery power in a mobile terminal over predetermined time duration. In this embodiment, the mobile terminal may be a mobile phone such as a smartphone with the Windows Phone system or a tablet PC, or a tablet. The Windows Phone smartphone may be used as an example for the sake of illustration throughout the description of the embodiments. Other mobile terminals may also be used without limiting the scope of the disclosure.

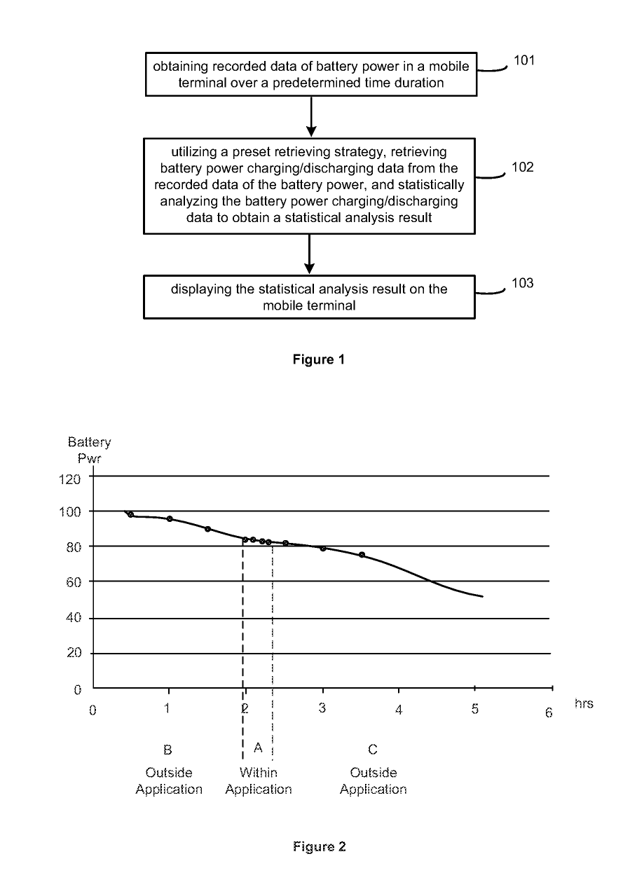

Prior to analyzing the smartphone battery power capacity and facilitating reasonable power usage, battery power data may be recorded and first obtained over a time duration (for example, one week or one month) after powering-on. After powering-on the smartphone, battery power data may be recorded at regular intervals (for example, every minute) over predetermined time duration (for example, one week). The foregoing recorded battery power data within the predetermined time duration may be used as the basis for subsequent statistical analysis of battery power consumption of the smartphone. A time vs battery power curve may be plotted according to all the recorded data points of the battery power over the corresponding time, as shown in FIG. 2.

Step S102: Utilizing a preset retrieving strategy, retrieving battery power charging/discharging data from the recorded data of the battery power, and statistically analyzing the battery power charging/discharging data to obtain a statistical analysis result.

Step S103: Displaying the statistical analysis result on the mobile terminal. The battery charging/discharging status may be statistically analyzed in order that the user may know the projected power consumption and the charging status of the battery to make an informed decision on the operations of the mobile terminal.

For example, the average power consumption of the smartphone in non-networked, 2G networked, and 3G networked states may be evaluated and the average power consumption of the smartphone in each operation status may be displayed to the user to enable the user to make decisions to keep certain operations (e.g., Internet connections, games, location tracking, movie streaming) open or closed based on a more accurate and realistic battery power capacity forecast.

Statistical analysis of the battery power charging status may be used to obtain the data on battery power charging capacity over a predetermined time duration (for example, one week), so as to judge whether the smartphone has undergone full-capacity charging within the time duration. If not, the user may be prompted to undergo full-capacity charging within the time duration. In addition, reasonable suggestions (i.e., closing certain opened applications which are not active) may be provided to the user in order to improve the mobile terminal performance and prolong the remaining battery power left. When displaying the statistical analysis result, information as to whether the smartphone has undergone full-capacity charging within the current predetermined time duration may offer reasonable suggestions to the user to perform full-capacity charging after certain time duration.

In another embodiment of the disclosure, the obtaining of the recorded data of the battery power in the mobile terminal within the predetermined time duration may include the following: upon powering-on of the mobile terminal, recording data of the battery power at regular intervals within every predetermined time duration in order to obtain corresponding recorded data points of the battery power; and obtaining all recorded data points of the battery power of the mobile terminal within the predetermined time duration, and plotting a time vs battery power curve according to all the recorded data points of the battery power and corresponding time in order to obtain the recorded data of the battery power in the mobile terminal within the predetermined time duration.

Take for example the Windows Phone smartphone as an example; instead of recording the battery power only at every interval after half an hour outside the applications (see regions B or C in FIG. 2), the smart may instead recording data of the battery power at every interval after a first time duration to obtain corresponding recorded data points of the battery power over a predetermined time duration after powering-on of the smartphone. If the smartphone operates one or more applications within a time duration (see region A in FIG. 2), such as the user clicks a button displayed on the smartphone to launch a “QQ” application, the battery power data may be recorded at every corresponding interval after a second time duration until all recorded data points are obtained.

Specifically, assuming that the first time duration may be half an hour and the second time duration may be one minute; then, the battery power may be recorded at every interval after half an hour when the smartphone stays beyond the time duration of the applications (in regions B or C in FIG. 2), and the battery power may be recorded at every interval after one minute after the smartphone stays within the time duration of the applications (in region A in FIG. 2). The foregoing time duration is illustrated only as an example without limitation, and may be set as needed.

According to the above mentioned data recording rules, all recorded data points of the battery power may be obtained within the predetermined time duration (for example, one week). When all recorded data points of the battery power and corresponding time are recorded, a time vs battery power curve may be plotted to display the status of battery power within certain time duration as well as the states of the battery power being in the discharging, charging, or idle states.

Assuming that the battery is not being charged or the battery has been interruptedly in its use within certain time duration, a recording curve on power consumption may be obtained (as shown in FIG. 2). Referring to FIG. 2, each point may represent a battery power data point record. When the smartphone stays beyond the time duration of the applications (i.e., in regions B or C), the mobile terminal charging/discharging system may record one point at every interval after half an hour; when the smartphone stays within the time duration of the applications. The mobile terminal charging/discharging system may record one point at every interval after one minute, thus increasing the number of recorded samples on the data of battery power and improving the accuracy of statistics of battery power. Further, power consumption of the battery may be evaluated utilizing a limited number of recorded data points of the battery power.

The foregoing technical solution analyzes the use status of the battery utilizing a limited number of recorded data points of the battery power, and evaluates the power consumption of the smartphone in different network states. The user may accordingly better manage the battery power prudently in different operation statuses based on a more accurate forecasted on the power consumption, and decide to continue staying or simply close on certain operations (for example, Internet access) to preventing unnecessary battery power waste. Since the charging status of the battery power is based on a statistical analysis over a longer duration (e.g., within one week or one month) to take into account of user's charging behaviors, the performance duration of the battery power may be prolonged including the service life of the battery itself (i.e., optimizing by reducing unnecessary charging cycles).

The following sections further elaborate the process of statistical analysis on recorded battery power data of a mobile terminal in a battery charging/discharging state:

(I) Statistical Analysis of Battery Power Consumption of the Mobile Terminal:

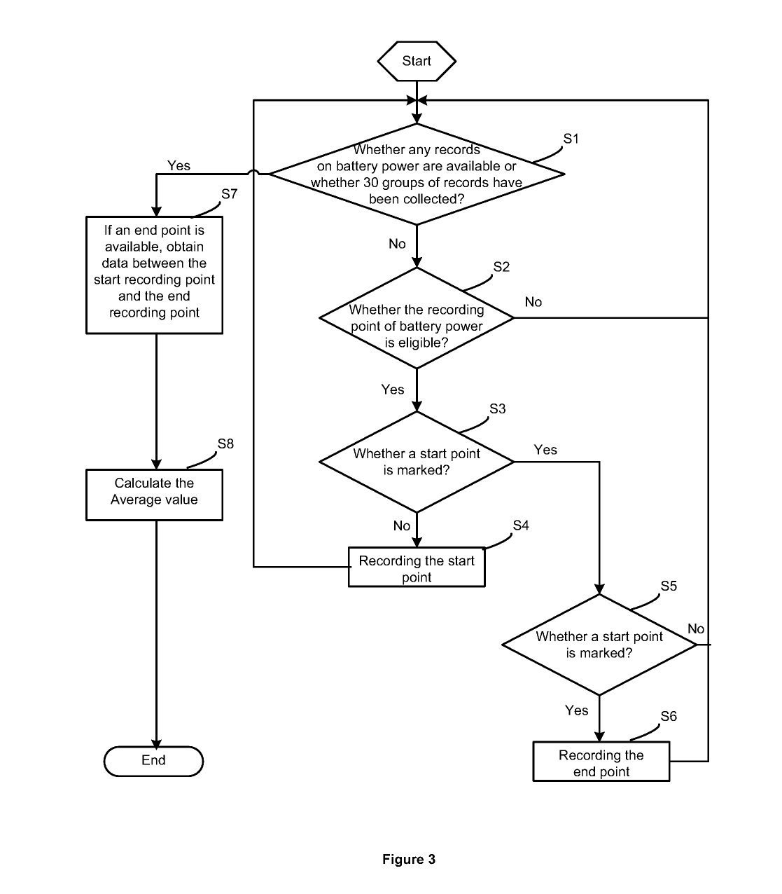

FIG. 3 shows a flowchart illustrating an exemplary statistical analysis of battery power consumption of a mobile terminal, according to an embodiment of the disclosure. As shown in FIG. 3, battery discharging capacity data may be retrieved from the recorded data on battery power in order to statistically analyze the battery discharging capacity data and to obtain a respective statistical analysis result.

For example, a preset number of groups of curve section samples of battery power discharging data of the mobile terminal in each operation status may be retrieved or extracted from the time vs battery power curve (i.e., obtained recorded data of battery power in FIG. 2). Corresponding samples of battery power discharging data may be retrieved from each of the plotted sections in the time vs battery power curve in order to calculate the average power consumption of the mobile terminal in each operation status.

The foregoing operation status may be a non-networked state, 2G networked state, or 3G networked state. As shown in FIG. 3, the step of retrieving a preset number of groups of curve section samples of battery power discharging data of the mobile terminal in each operation status from the recorded battery power data may include at least the following operations:

Step S1: Following the time vs battery power curve, traversing in a forward direction the recorded data points of the battery power; judging whether a recorded data points of the battery power is currently available or whether a preset group number of battery power records (30 groups of battery power records in this example) have been collected; if yes, proceeding to Step S7; otherwise, proceeding to Step S2.

Step S2: Judging whether the current recording point of battery power is eligible, that is, judging whether the current recording point of battery power is in a power-consuming state and stays within a specific network state (e.g., non-networked, 2G networked, or 3G networked). If yes, proceeding to Step S3; otherwise, returning to Step S1.

Step S3: Judging whether a start point is marked; if yes, proceeding to Step S4; otherwise, proceeding to Step S5.

Step S4: Recording a start point; utilizing the start recording point as a current end point; returning to Step S1.

Step S5: Judging whether the current recording point is eligible, that is, comparing the current recording point with the current end point, and utilizing the current recording point as the current end point if the battery power at the current recording point is smaller than the battery power at the current end point, and judging if the time interval between the current recording point and the current end point is less than one hour; If yes, proceeding to Step S6; otherwise, returning to Step S1.

Step S6: Recording the current end point, and returning to Step S1.

Step S7: If a current end point is available, obtaining data between the start recording point and the current end point and adding the data on power consumption and the corresponding time within this time duration; proceeding to Step S8.

Step S8: Calculating the general average value. Upon completing the cycle, having the cumulative power consumption divided by time duration, and thus obtaining an average power consumption.

In the foregoing process, utilizing the start recording point as a current end point, selecting in a forward direction a current recording point which is compliant to the selected operation status in the mobile terminal, and comparing the current recording point with the current end point; if the battery power at the current recording point is larger than the battery power at the current end point, and if a time interval between the current recording point and the current end point is less than a predetermined time, updating the current recording point as the current end point; continue updating until when an obtained current recording point is no longer compliant to the selected operation status in the mobile terminal: using the curved section between the current end point and the start recording point as a group of curve section samples of battery power discharging data being the selected current operation status of the mobile terminal; repeating foregoing processes following a sequence until obtaining the preset number of groups of curve section samples of battery power discharging data of the mobile terminal in the selected current operation status.

Finally, according to the time vs battery power curve, obtaining the time and an associated power discharged by the battery to correspond to the samples of battery power discharging data from each of the plotted sections. Then, calculating the average power consumption of the mobile terminal in each operation status according to the time and an associated power discharged by the battery to correspond to the samples of battery power discharging data from each of the plotted sections.

As a result, the system may display the foregoing average power consumption of the mobile terminal in different operation statuses for the user. In this regard, the user may know the average power consumption of the mobile terminal in different operation statuses and use the battery power prudently in different operation statuses of the mobile phone. According to the power consumption of the battery in different operation statuses, the user may also forecast the battery power, thus arranging the operations (for example, Internet access) of the mobile phone prudently and preventing use of the mobile phone from being affected by the unforeseeable battery power.

(II) Statistical Analysis of Battery Charging of the Mobile Terminal:

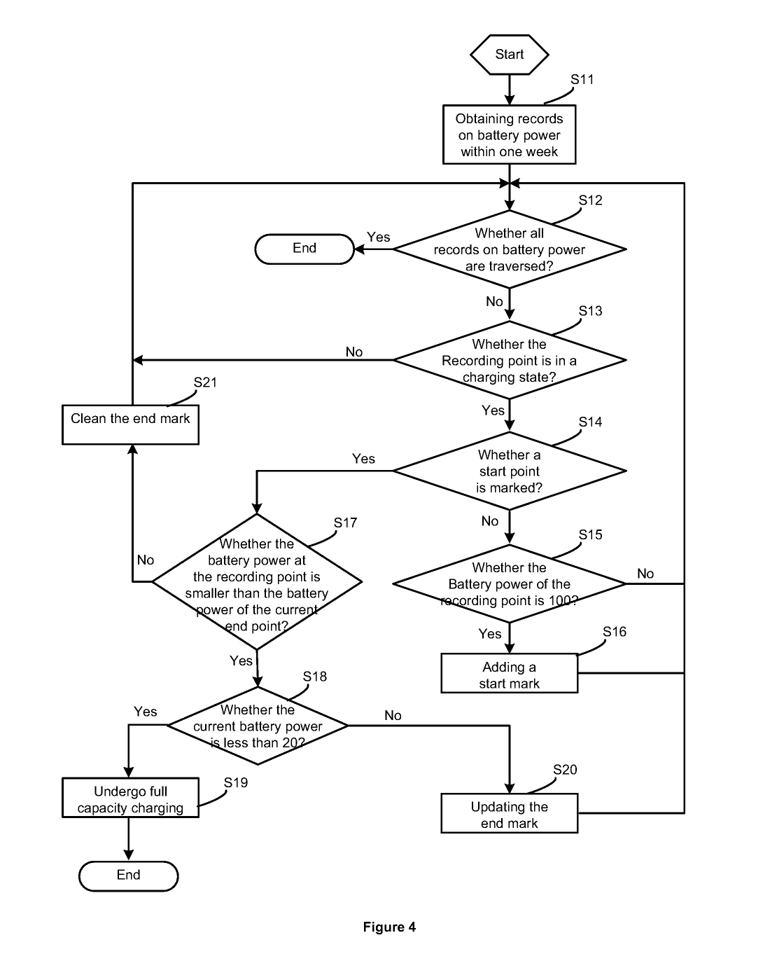

FIG. 4 shows a flowchart illustrating an exemplary statistical analysis of battery power charging capacity of a mobile terminal, according to an embodiment of the disclosure. As shown in FIG. 4, there is shown that the battery power charging data is retrieved or extracted from the recorded data on battery power. The retrieved data is statistically analyzed on its charging capacity, and obtain a statistical analysis result.

Specifically, the battery power charging data may be retrieved over a predetermined time duration from the recorded data on battery power; according to the time vs battery power curve, traverse the recorded data points of the battery power within the predetermined time duration in a forward direction, and finally obtain the data on battery charging within the predetermined time duration.

As shown in FIG. 4, by taking one week as an example of a predetermined time duration, the foregoing process may further include the following operations:

Step S11: Obtaining the battery charging records of one week, and traverse the battery charging records in a forward direction.

Step S12: Judging whether all records on battery power are traversed; if yes, ending the operation; otherwise, proceeding to Step S13.

Step S13: Judging whether the current recording point is in charging state; if yes, proceeding to Step S14; otherwise, returning to Step S12.

Step S14: Judging whether a start point is marked; if yes, proceeding to Step S17; otherwise, proceeding to Step S15.

Step S15: Judging whether the current recording point is in full-capacity charging state; if yes, proceeding to Step S16; otherwise, returning to Step S12.

Step S16: Adding a start mark; and returning to Step S12.

Step S17: Comparing the current recording point with the end point; if the battery power at the current recording point is less than the battery power at the end point and the time interval between the current recording point and the end point is less than one hour, proceeding to Step S18; otherwise, returning to Step S12.

Step S18: Judging whether the current battery power is less than 20%; if yes, proceeding to Step S19; otherwise, proceeding to Step S20.

Step S19: Judging that the battery has undergone full-capacity charging within the one week.

Step S20: Updating the mark of the end point, and returning to Step S12.

To summarize the foregoing process, the operations include: retrieving the battery power charging data from the recorded data on battery power over the predetermined time duration; following the time vs power curve, traversing in a forward direction the recorded data points of the battery power; obtaining the recording point of battery power at full capacity as being the start recording point; utilizing the start recording point as a current end point, selecting current recording points in a forward direction, and comparing the selected current recording points with the current end point; if the battery power of the current recording point is less than the battery power of the current end point, and the time interval between the current recording point and the current end point is less than a predetermined time duration, updating the current recording point as being the current end point; and determining that the mobile terminal has undergone full-capacity charging within the current predetermined time duration and continue updating until the battery power of the obtained current recording point is less than a preset threshold (for example, 20%); otherwise, determining that the mobile terminal has not undergone the full-capacity charging within the current predetermined time duration and displaying the result for the user.

The displaying of the statistical analysis may include at least one or more of: an average power consumption of the mobile terminal in each operation status on the mobile terminal; and information of whether the mobile terminal has undergone full-capacity charging within current predetermined time duration on the mobile terminal.

Through the foregoing technical solution, this embodiment analyzes the use status of the battery utilizing a limited number of recorded data points of the battery power, and evaluates the power consumption of the smartphone in different network states, so that the user may use the battery power prudently in different operation statuses, or forecast the battery power according to the power consumption of the battery in different operation statuses, thus arranging the operations (for example, Internet access) of the smartphone prudently and preventing use of the smartphone from being affected by unforeseeable battery power. According to the charging status of the battery within one week or one month, this embodiment may offer suggestions on the user's charging behaviors, thus improving the performance of the battery, prolonging the service life of the battery, and maintaining the battery in an optimal operation status.

FIG. 5 shows exemplary schematic functional modules which record and analyze battery power data of a mobile terminal, according to an embodiment of the disclosure. In an embodiment, the device (200) may be a portion of or the entire mobile terminal, such as a mobile phone or a tablet PC, especially a smartphone with the Windows Phone system.

The device (200) may include at least a processor (270) with circuitry operating in conjunction with at least a memory (260) which stores instruction codes operable as plurality of modules, wherein the plurality of modules may include an acquisition module (201), a retrieving and analyzing module (202) and a display module (203).

The acquisition module (201) obtains recorded data of battery power in a mobile terminal over predetermined time duration. The retrieving and analyzing module (202) utilizes a preset retrieving strategy, retrieves battery power charging/discharging data from the recorded data of the battery power, and statistically analyzes the battery power charging/discharging data to obtain a statistical analysis result. The displaying module (203) which displays the statistical analysis result on the mobile terminal.

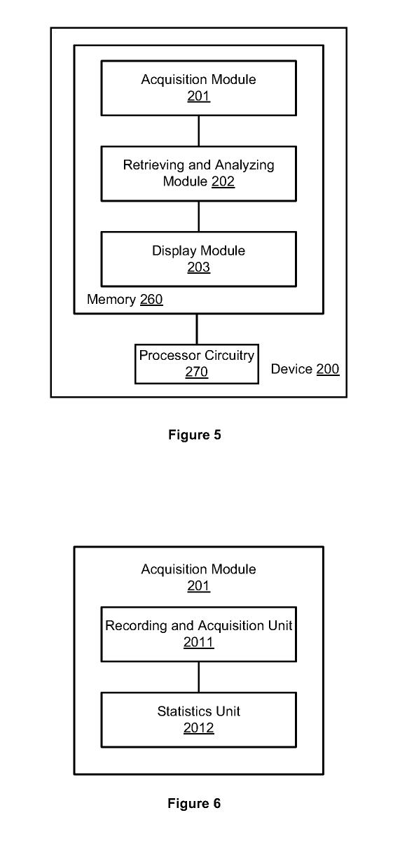

FIG. 6 shows a detail schematic functional diagram of an acquisition module (201) of the device for recording and analyzing the battery power of a mobile terminal, according to an embodiment of the disclosure. The acquisition module (201) may include: a recording and acquisition unit (2011) and a statistics unit (2012), wherein:

The recording and acquisition unit (2011) upon powering-on of the mobile terminal, records data of the battery power at regular intervals within every predetermined time duration in order to obtain corresponding recorded data points of the battery power; and obtains all recorded data points of the battery power of the mobile terminal within the predetermined time duration.

The statistics unit (2012) plots a time vs power curve according to all the recorded data points of the battery power and corresponding time in order to obtain the recorded data of the battery power in the mobile terminal within the predetermined time duration.

The recording and acquisition unit (2011) is further utilized within the predetermined time duration after the mobile terminal has powered-on and prior to the mobile terminal entering an application time duration: records at regular intervals of a first time duration, the data of the battery power in order to obtain corresponding plurality of first recorded data points of the battery power; after the mobile terminal stays within a time duration of applications: records at regular intervals of a second time duration, the data of the battery power in order to obtain corresponding plurality of second recorded data points of the battery power; and obtains corresponding plurality of all recorded data points of the battery power of the mobile terminal.

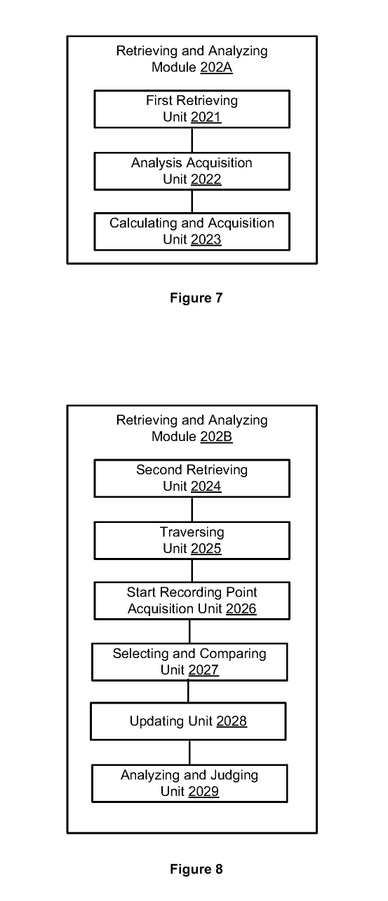

FIG. 7 shows a detail schematic functional diagram of a retrieving and analyzing module of the device for recording and analyzing the battery power of a mobile terminal, according to an embodiment of the disclosure. In an disclosed embodiment, the retrieving and analyzing module (202A) in the application scenario of statistical analysis of battery power consumption of a mobile terminal may include: a first retrieving unit (2021), an analysis acquisition unit (2022), and a calculating and acquisition unit (2023), wherein:

The first retrieving unit (2021) retrieves from the recorded data of the battery power of the mobile terminal, a preset number of groups of curve section samples of battery power discharging data of each operation status.

The analysis acquisition unit (2022) utilizes the time vs power curve to obtain from each of the curve section samples of the battery power discharging data, a time and a corresponding amount of battery power that has been discharged;

The calculating and acquisition unit (2023) calculates an average power consumption of each operation status in the mobile terminal according to the corresponding time and according to the corresponding amount of battery power that has been discharged from each of the curve section samples.

In addition, the first retrieving unit (2021) performs the following: following the time vs power curve, traverses in a forward direction the recorded data points of the battery power; obtains a recording point of battery power compliant to a selected operation status in the mobile terminal being a start recording point; utilizing the start recording point as a current end point, selects in a forward direction a current recording point which is compliant to the selected operation status in the mobile terminal, and comparing the current recording point with the current end point; if the battery power at the current recording point is larger than the battery power at the current end point, and if a time interval between the current recording point and the current end point is less than a predetermined time, updates the current recording point as the current end point; continues to update until when an obtained current recording point is no longer compliant to the selected operation status in the mobile terminal, utilizing the curved section between the current end point and the start recording point as a group of curve section samples of battery power discharging data being the selected current operation status of the mobile terminal; and repeats foregoing processes following a sequence until obtaining the preset number of groups of curve section samples of battery power discharging data of the mobile terminal in the selected current operation status.

FIG. 8 shows another detail schematic functional diagram of the retrieving and analyzing module of the device for recording and analyzing the battery power of a mobile terminal, according to an embodiment of the disclosure. In the another embodiment, the retrieving and analyzing module (202B) may include: a second retrieving unit (2024), a traversing unit (2025), a start recording point acquisition unit (2026), a selecting and comparing unit (2027), an updating unit (2028), and an analyzing and judging unit (2029).

More specifically, the second retrieving unit (2024) may retrieve the battery power charging data from the recorded data on battery power over the predetermined time duration. The a traversing unit (2025) may follow the time vs power curve and traverses in a forward direction the recorded data points of the battery power. The start recording point acquisition unit (2026) may obtain the recording point of battery power at full capacity as being the start recording point. The selecting and comparing unit (2027) may utilize the start recording point as a current end point to select current recording points in a forward direction, and comparing the selected current recording points with the current end point.

The updating unit (2028) may update the current recording point as being the current end point, if the battery power of the current recording point is less than the battery power of the current end point, and the time interval between the current recording point and the current end point is less than a predetermined time duration;

The analyzing and judging unit (2029) may determines that the mobile terminal has undergone full-capacity charging within the current predetermined time duration and continues updating until the battery power of the obtained current recording point is less than a preset threshold; and

Through the foregoing technical solution, this embodiment analyzes the use status of the battery utilizing a limited number of recorded data points of the battery power, and evaluates the power consumption of the smartphone in different network states, so that the user may use the battery power prudently in different operation statuses, or forecast the battery power according to the power consumption of the battery in different operation statuses, thus arranging the operations (for example, Internet access) of the smartphone prudently and preventing use of the smartphone from being affected by unforeseeable battery power. According to the charging status of the battery within one week or one month, this embodiment may offer suggestions on the user's charging behaviors, thus improving the performance of the battery, prolonging the service life of the battery, and maintaining the battery in an optimal operation status.

Further, the embodiments of the present disclosure provide a system operation platform, which the system includes the device as described in the foregoing embodiments.

The method, device, platform, and mobile terminal for recording and analyzing the battery power of a mobile terminal provided in embodiments of the present disclosure work on the following principle: retrieving the data on battery charging/discharging from the recorded battery power data over a predetermined time duration, statistically analyzing the data of charging/discharging capacity, and displaying the statistical analysis result on the mobile terminal for the user. Therefore, embodiments not only improve the accuracy of statistical data on battery power, but also provide more accurate analysis and forecast of battery use status according to the statistical data on battery power, thus facilitating reasonable use of the battery power. In addition, they may further offer reasonable suggestions on the battery power usage according to the recorded data on the battery power.

The foregoing step sequence of the present disclosure is used for illustrating the embodiments only. They do not represent any superiority or inferiority of the embodiments.

It should be understood by those with ordinary skill in the art that all or some of steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory.

The foregoing represents only some preferred embodiments of the present disclosure and their disclosure may not be construed to limit the present disclosure in any way. Those of ordinary skill in the art may recognize that equivalent embodiments may be created via slight alterations and modifications utilizing the technical content disclosed above without departing from the scope of the technical solution of the present disclosure, and such summary alterations, equivalent has changed and modifications of the foregoing embodiments are to be viewed as being within the scope of the technical solution of the present disclosure.

1. A method for recording and analyzing the battery power of a mobile terminal, comprising:
obtaining recorded data of battery power in a mobile terminal over a predetermined time duration;
utilizing a preset retrieving strategy by performing retrieving battery power charging/discharging data from the recorded data of the battery power, and statistically analyzing the battery power charging/discharging data to obtain a statistical analysis result, wherein the retrieving strategy comprising:
retrieving from the recorded data of the battery power of the mobile terminal, a preset number of groups of curve section samples of battery power discharging data of each operation status;
utilizing a time vs battery power curve, obtaining from each of the curve section samples of the battery power discharging data, a time and a corresponding amount of battery power that has been discharged; and
calculating an average power consumption of each operation status in the mobile terminal according to the corresponding time and according to the corresponding amount of battery power that has been discharged from each of the curve section samples; and
displaying the statistical analysis result on the mobile terminal.

2. The method according to claim 1, wherein the obtaining of the recorded data of the battery power in the mobile terminal within the predetermined time duration, comprising:
upon powering-on of the mobile terminal, recording data of the battery power at regular intervals within every predetermined time duration in order to obtain corresponding recorded data points of the battery power; and obtaining all recorded data points of the battery power of the mobile terminal within the predetermined time duration; and
plotting the time vs battery power curve according to all the recorded data points of the battery power and corresponding time in order to obtain the recorded data of the battery power in the mobile terminal within the predetermined time duration.

3. The method according to claim 2, wherein upon powering-on of the mobile terminal, the recording of the data of the battery power at regular intervals within every predetermined time duration, the obtaining of the corresponding recorded data points of the battery power; and the obtaining of all recorded data points of the battery power of the mobile terminal over the predetermined time duration, comprising:
within the predetermined time duration after the mobile terminal has powered-on and prior to the mobile terminal entering an application:
recording at regular intervals of a first time duration, the data of the battery power in order to obtain corresponding plurality of first recorded data points of the battery power;
after the mobile terminal stays within a time duration of applications:
recording at regular intervals of a second time duration, the data of the battery power in order to obtain corresponding plurality of second recorded data points of the battery power; and
obtaining corresponding plurality of all recorded data points of the battery power of the mobile terminal.

4. The method according to claim 1, wherein the retrieving from the recorded data of the battery power of the mobile terminal, the preset number of groups of curve section samples of battery power discharging data of each operation status, comprising:
following the time vs battery power curve, traversing in a forward direction the recorded data points of the battery power;
obtaining a recording point of battery power compliant to a selected operation status in the mobile terminal as being a start recording point;
utilizing the start recording point as a current end point, selecting in a forward direction a current recording point which is compliant to the selected operation status in the mobile terminal, and comparing the current recording point with the current end point;
if the battery power at the current recording point is larger than the battery power at the current end point, and if a time interval between the current recording point and the current end point is less than a predetermined time, updating the current recording point as the current end point; continue updating until when an obtained current recording point is no longer compliant to the selected operation status in the mobile terminal: utilizing the curved section between the current end point and the start recording point as a group of curve section samples of battery power discharging data being the selected current operation status of the mobile terminal; and
repeating foregoing processes following a sequence until obtaining the preset number of groups of curve section samples of battery power discharging data of the mobile terminal in the selected current operation status.

5. The method according to claim 2, wherein the utilizing of the preset retrieving strategy in retrieving of battery power charging data from the recorded data of the battery power, and statistically analyzing the battery power charging data to obtain the statistical analysis result, comprising:
retrieving the battery power charging data from the recorded data on battery power over the predetermined time duration;
following the time vs battery power curve, traversing in a forward direction the recorded data points of the battery power;
obtaining the recording point of battery power at full capacity as being the start recording point;
utilizing the start recording point as a current end point, selecting current recording points in a forward direction, and comparing the selected current recording points with the current end point;
if the battery power of the current recording point is less than the battery power of the current end point, and the time interval between the current recording point and the current end point is less than a predetermined time duration, updating the current recording point as being the current end point; and
determining that the mobile terminal has undergone full-capacity charging within the current predetermined time duration and continue updating until the battery power of the obtained current recording point is less than a preset threshold; otherwise, determining that the mobile terminal has not undergone the full-capacity charging within the current predetermined time duration.

6. The method according to claim 1, wherein the displaying of the statistical analysis result on the mobile terminal, comprising displaying at least one or more of:
an average power consumption of the mobile terminal in each operation status on the mobile terminal; and
information of whether the mobile terminal has undergone full-capacity charging within current predetermined time duration on the mobile terminal.

7. A device for recording and analyzing the battery power of a mobile terminal, comprises at least a processor with circuitry operating in conjunction with at least a memory which stores instruction codes operable as plurality of modules which cause the device to perform functions, wherein the plurality of modules comprise:
an acquisition module, which obtains recorded data of battery power in a mobile terminal over a predetermined time duration;
an retrieving and analyzing module, which utilizes a preset retrieving strategy to retrieve battery power charging/discharging data from the recorded data of the battery power, and statistically analyze the battery power charging/discharging data in order to obtain a statistical analysis result;
wherein the retrieving and analyzing module comprises:
a first retrieving unit, which retrieves from the recorded data of the battery power of the mobile terminal, a preset number of groups of curve section samples of battery power discharging data of each operation status;
an analysis acquisition unit, which utilizes a time vs battery power curve to obtain from each of the curve section samples of the battery power discharging data, a time and a corresponding amount of battery power that has been discharged; and
a calculating and acquisition unit, which calculates an average power consumption of each operation status in the mobile terminal according to the corresponding time and according to the corresponding amount of battery power that has been discharged from each of the curve section samples; and
a displaying module, which displays the statistical analysis result on the mobile terminal.

8. The device according to claim 7, wherein the acquisition module comprises:
a recording and acquisition unit, which upon powering-on of the mobile terminal, records data of the battery power at regular intervals within every predetermined time duration in order to obtain corresponding recorded data points of the battery power; and obtains all recorded data points of the battery power of the mobile terminal within the predetermined time duration; and
a statistics unit, which plots the time vs battery power curve according to all the recorded data points of the battery power and corresponding time in order to obtain the recorded data of the battery power in the mobile terminal within the predetermined time duration.

9. The device according to claim 8, wherein within the predetermined time duration after the mobile terminal has powered-on and prior to the mobile terminal entering an application, the recording and acquisition unit causes the device to:
record at regular intervals of a first time duration, the data of the battery power in order to obtain corresponding plurality of first recorded data points of the battery power;
wherein after the mobile terminal stays within a time duration of applications: record at regular intervals of a second time duration the data of the battery power in order to obtain corresponding plurality of second recorded data points of the battery power; and
obtain corresponding plurality of all recorded data points of the battery power of the mobile terminal.

10. The device according to claim 9, wherein the first retrieving unit causes the device to perform the following:
following the time vs battery power curve, traverses in a forward direction the recorded data points of the battery power;
obtaining a recording point of battery power compliant to a selected operation status in the mobile terminal as being a start recording point;
utilizing the start recording point as a current end point, selects in a forward direction a current recording point which is compliant to the selected operation status in the mobile terminal, and comparing the current recording point with the current end point;
if the battery power at the current recording point is larger than the battery power at the current end point, and if a time interval between the current recording point and the current end point is less than a predetermined time:
updating the current recording point as the current end point; continues to update until when an obtained current recording point is no longer compliant to the selected operation status in the mobile terminal,
utilizing the curved section between the current end point and the start recording point as a group of curve section samples of battery power discharging data being the selected current operation status of the mobile terminal; and
repeating foregoing processes following a sequence until the preset number of groups of curve section samples of battery power discharging data of the mobile terminal in the selected current operation status are obtained.

11. The device according to claim 8, wherein the retrieving and analyzing module comprises:
a second retrieving unit, which retrieves the battery power charging data from the recorded data on battery power over the predetermined time duration;
a traversing unit, which follows the time vs battery power curve and traverses in a forward direction the recorded data points of the battery power;
a start recording point acquisition unit, which obtains the recording point of battery power at full capacity as being the start recording point;
a selecting and comparing unit, which utilizes the start recording point as a current end point to select current recording points in a forward direction, and compares the selected current recording points with the current end point;
an updating unit, which if the battery power of the current recording point is less than the battery power of the current end point, and the time interval between the current recording point and the current end point is less than a predetermined time duration, updates the current recording point as being the current end point;
an analyzing and judging unit, which:
determines that the mobile terminal has undergone full-capacity charging within the current predetermined time duration and continues updating until the battery power of the obtained current recording point is less than a preset threshold;
determines that the mobile terminal has undergone full-capacity charging within the current predetermined time duration when the battery power of the obtained current recording point is less than a preset threshold; and
determines that the mobile terminal has not undergone full-capacity charging within the current predetermined time duration when the battery power of the obtained current recording point is larger than the preset threshold.

12. The device according to claim 7, wherein the displaying unit displays at least one or more of:
an average power consumption of the mobile terminal in each operation status on the mobile terminal; and
information of whether the mobile terminal has undergone full-capacity charging within current predetermined time duration on the mobile terminal.

13. A non-transitory computer-readable storage medium, wherein the computer readable storage medium stores a program which comprises codes or instructions to cause a processor circuitry to execute operations for recording and analyzing the battery power of a mobile terminal, the operations comprising:
obtaining recorded data of battery power in a mobile terminal over a predetermined time duration;
utilizing a preset retrieving strategy by performing retrieving battery power charging/discharging data from the recorded data of the battery power, and statistically analyzing the battery power charging/discharging data to obtain a statistical analysis result, wherein the retrieving strategy comprising:
retrieving from the recorded data of the battery power of the mobile terminal, a preset number of groups of curve section samples of battery power discharging data of each operation status;
utilizing a time vs battery power curve, obtaining from each of the curve section samples of the battery power discharging data, a time and a corresponding amount of battery power that has been discharged; and
calculating an average power consumption of each operation status in the mobile terminal according to the corresponding time and according to the corresponding amount of battery power that has been discharged from each of the curve section samples; and
displaying the statistical analysis result on the mobile terminal.

14. The non-transitory computer-readable storage medium according to claim 13, wherein the obtaining of the recorded data of the battery power in the mobile terminal within the predetermined time duration, comprising:
upon powering-on of the mobile terminal, recording data of the battery power at regular intervals within every predetermined time duration in order to obtain corresponding recorded data points of the battery power; and obtaining all recorded data points of the battery power of the mobile terminal within the predetermined time duration; and
plotting a time vs battery power curve according to all the recorded data points of the battery power and corresponding time in order to obtain the recorded data of the battery power in the mobile terminal within the predetermined time duration.

15. The non-transitory computer-readable storage medium according to claim 14, wherein upon powering-on of the mobile terminal, the recording of the data of the battery power at regular intervals within every predetermined time duration, the obtaining of the corresponding recorded data points of the battery power; and the obtaining of all recorded data points of the battery power of the mobile terminal over the predetermined time duration, comprising:
within a predetermined time duration after the mobile terminal has powered-on and prior to the mobile terminal entering an application:
recording at regular intervals of a first time duration, the data of the battery power in order to obtain corresponding plurality of first recorded data points of the battery power;
after the mobile terminal stays within a time duration of applications:
recording at regular intervals of a second time duration, the data of the battery power in order to obtain corresponding plurality of second recorded data points of the battery power; and
obtaining corresponding plurality of all recorded data points of the battery power of the mobile terminal.

16. The non-transitory computer-readable storage medium according to claim 13, wherein the retrieving from the recorded data of the battery power of the mobile terminal, the preset number of groups of curve section samples of battery power discharging data of each operation status, comprising:
following the time vs battery power curve, traversing in a forward direction the recorded data points of the battery power;
obtaining a recording point of battery power compliant to a selected operation status in the mobile terminal as being a start recording point;
utilizing the start recording point as a current end point, selecting in a forward direction a current recording point which is compliant to the selected operation status in the mobile terminal, and comparing the current recording point with the current end point;
if the battery power at the current recording point is larger than the battery power at the current end point, and if a time interval between the current recording point and the current end point is less than a predetermined time, updating the current recording point as the current end point; continue updating until when an obtained current recording point is no longer compliant to the selected operation status in the mobile terminal: using the curved section between the current end point and the start recording point as a group of curve section samples of battery power discharging data being the selected current operation status of the mobile terminal; and
repeating foregoing processes following a sequence until obtaining the preset number of groups of curve section samples of battery power discharging data of the mobile terminal in the selected current operation status.

17. The non-transitory computer-readable storage medium according to claim 14, wherein the utilizing of the preset retrieving strategy in retrieving of battery power charging data from the recorded data of the battery power, and statistically analyzing the battery power charging data to obtain the statistical analysis result, comprising:
retrieving the battery power charging data from the recorded data on battery power over the predetermined time duration;
following the time vs battery power curve, traversing in a forward direction the recorded data points of the battery power;
obtaining the recording point of battery power at full capacity as being the start recording point;
utilizing the start recording point as a current end point, selecting current recording points in a forward direction, and comparing the selected current recording points with the current end point;
if the battery power of the current recording point is less than the battery power of the current end point, and the time interval between the current recording point and the current end point is less than a predetermined time duration, updating the current recording point as being the current end point; and
determining that the mobile terminal has undergone full-capacity charging within the current predetermined time duration and continue updating until the battery power of the obtained current recording point is less than a preset threshold; otherwise, determining that the mobile terminal has not undergone the full-capacity charging within the current predetermined time duration.

18. The non-transitory computer-readable storage medium according to claim 13, wherein the displaying of the statistical analysis result on the mobile terminal, comprising displaying at least one or more of:
an average power consumption of the mobile terminal in each operation status on the mobile terminal; and
information of whether the mobile terminal has undergone full-capacity charging within current predetermined time duration on the mobile terminal.
